(19) United States
(12) Patent Application Publication
(10) Pub. No.: US 2020/0384707 A1
(43) Pub. Date: Dec. 10, 2020

(54) SYSTEM AND METHOD FOR MANUFACTURING PREFORMS FOR A WIND TURBINE ROTOR BLADE

(71) Applicant: LM WIND POWER INTERNATIONAL TECHNOLOGY II APS, kolding (DK)

(72) Inventor: Kristian LEHMANN MADSEN, Kolding (DK)

(21) Appl. No.: 16/772,596

(22) PCT Filed: Dec. 6, 2018
(86) PCT No.: PCT/EP2018/083766

§ 371 Date: Jun. 12, 2020

(30) Foreign Application Priority Data
Dec. 14, 2017 (EP) 17207314.0

(51) Int. Cl. B29C 70/38; F03D 1/06; B29C 70/84; B29C 70/06; B29C 70/68; B29C 35/02; B29C 33/00; B29C 70/48

(52) U.S. Cl. CPC B29C 70/38; F03D 1/0675; B29C 70/84; B29C 70/06; B29L 2031/085; B29C 35/02; B29C 33/00; B29C 70/48; F05B 2230/21; B29C 70/683

(57) ABSTRACT

The present invention relates to a manufacturing system and to a method for the manufacture of preforms for wind turbine blade parts. The system comprises two or more preform moulds (70), a fibre lay-up station (88) for placing a fibre material into the preform moulds (70), and a heating station (90) for heating the fibre material to form the preforms. At least two of the preform moulds (70) have substantially identical width W and substantially identical height H.

### FIELD OF THE INVENTION

The present invention relates to a manufacturing system and a method for the manufacture of preforms for wind turbine blade parts.

### BACKGROUND OF THE INVENTION

The rotor blades of modern wind turbines capture kinetic wind energy by using sophisticated blade design created to maximise efficiency. There is an increasing demand for large wind blades which may exceed 80 metres in length and 4 metres in width. The blades are typically made from a fibre-reinforced polymer material and comprise a pressure side shell half and a suction side shell half, also referred to as blade halves. The cross-sectional profile of a typical blade includes an airfoil for creating an air flow leading to a pressure difference between both sides. The resulting lift force generates torque for producing electricity.

The shell halves of wind turbine blades are usually manufactured using blade moulds. First, a blade gel coat or primer is applied to the mould. Subsequently, fibre reinforcement and/or fabrics are placed into the mould followed by resin infusion. A vacuum is typically used to draw epoxy resin material into a mould. Alternatively, prepreg technology can be used in which a fibre or fabric pre-impregnated with resin forms a homogenous material which can be introduced into the mould. Several other moulding techniques are known for manufacturing wind turbine blades, including compression moulding and resin transfer moulding. The shell halves are assembled by being glued or bolted together substantially along a chord plane of the blade.

In the above-described manufacturing process, preforms may be used. A preform is a shaped arrangement of fibres, such as multiple layers thereof, which has been bound and/or consolidated for later use as part of the fibre lay-up in the blade mould. The rationale for using preforms for blade manufacturing is to reduce cycle time in the blade mould. Also, using preforms may reduce the number of required repairs due to the pre-consolidated structure of the preforms.

Typically, multiple preforms will be used in manufacturing a wind turbine blade. This usually requires large space for manufacturing and for storing the preforms. In addition, the manufacturing of preforms of different shapes and sizes can be time-consuming and expensive.

It is a first object of the present invention to provide a cost-efficient way of manufacturing preforms for wind turbine blade parts.

It is a further object of the present invention to provide a flexible and time-efficient mode of manufacturing such preforms.

### SUMMARY OF THE INVENTION

The present inventors have found that one or more of said objects may be achieved by a manufacturing system for the manufacture of preforms for wind turbine blade parts, the system comprising
two or more preform moulds, each preform mould having a width W, a height H and a length L,
a fibre lay-up station for placing a fibre material into the preform moulds, and
a heating station for heating the fibre material to form the preforms,
   wherein at least two of the preform moulds have substantially identical width W and substantially identical height H.

Preferably, the resulting preform is a consolidated arrangement of material comprising fibres, such as glass fibres, and a binding agent. The wind turbine blade part will typically be a blade half. The wind turbine blade part can be manufactured using the preforms. The preforms can be used in the subsequent blade moulding process as part of the fibre lay-up in the blade mould, such as a blade half mould. In a preferred embodiment, the preforms manufactured according to the present invention are placed within the root region of a blade mould, thus constituting part of the root laminate. The root region may correspond to a region of the blade having a substantially circular or elliptical cross-section. However, they could also be used for other parts and regions of a wind turbine blade, such as trailing edge or leading edge reinforcements or adhesive flanges.

By providing at least two of the preform moulds, such as at least three, four, five, six, seven or eight, or up to 20, of the preform moulds with substantially identical width W and substantially identical height H, a modular and unitary system of preform moulds can be created, which greatly facilitates the handling, transport and storage of the preform moulds both before and after moulding the preforms. A major advantage resides in the fact that such preform moulds can be stacked on top of each other, unlike prior art preform moulds of different shapes and sizes which occupy large space capacities of the work space. In some embodiments, two or more of the preform moulds differ in length. It was found that the above-described advantages also apply to such embodiments.

The fibre lay-up station will typically comprise one or more fibre lay-up devices. The heating station will typically comprise one or more heating devices, such as an oven. It is an advantage of the present invention that preform moulds of similar or unitary size can be more easily processed in the fibre lay-up station and in the heating station. For example, a single central oven could be used for heating, being suitable for the standardised size of the preform moulds, instead of providing expensive built-in heating in each preform mould. Thus, a more space-efficient and less costly heating regime is enabled by the present invention.

In a preferred embodiment, the heating station is configured for simultaneously accommodating the preform moulds. It is particularly preferred that the heating station comprises an oven for accommodating and heating multiple preform moulds simultaneously, such as at least two, at least three, at least four, or at least five preform moulds simultaneously.

Similarly, the fibre lay-up station can be designed centrally, thus efficiently accommodating the unitary preform mould size. Also, the present inventors have found that the features of the present invention allow for a high degree of automation of the manufacturing process of preforms for wind turbine blades.

The manufacturing system may include up to 20 preform moulds, such as up to 15 or up to 10 preform moulds, preferably per blade type. The material for making the preform moulds may include steel or a composite material, or a hybrid of steel and composite material. In a preferred embodiment, one fibre lay-up station and one heating station, such as an oven, could be used to produce preforms for more than one blade type at the same manufacturing location, or when shifting from one bade type to another. This has been found to result in a significant decrease of costs.

In one embodiment, the fibre lay-up station and the heating station are separate spatial locations. In another embodiment, the fibre lay-up station and the heating station are located in the same place, or at least close to each other, such that the preforms do not have to be transferred between the steps of fibre lay-up and heating. In some embodiments, the blade mould for moulding the blade part, such as a blade half, using the preforms, is installed at a separate location.

Preferably, a binding agent is added to the fibres prior to the heating step. Such binding agent is preferably present in an amount of 0.1-15 wt % relative to the weight of the fibre material. The binding agent may also be present in an amount of 10-20 gram per square meter of glass surface.

It is preferred that at least two of the preform moulds have substantially identical width W, substantially identical height H and substantially identical length L. In other embodiments at least three, such as at least four, five, six, seven or eight of the preform moulds have substantially identical width W, substantially identical height H and substantially identical length L

Usually, each preform mould will comprise a moulding surface for lay-up of fibre material to form the later preform. Preferably, the moulding surface is different for each preform mould of the manufacturing system. It is preferred that the respective moulding surfaces of the preform moulds are configured such that resulting preforms together form a root region of a blade half when arranged in an adjacent or overlapping configuration in a blade mould, wherein each preform extends from the root end of the blade mould towards the tip end. It is particularly preferred that all preform moulds have substantially identical width W and substantially identical height H, and optionally substantially identical length L.

In another preferred embodiment, all preform moulds have substantially identical width W, wherein in a first subgroup of two or more preform moulds, all preform moulds have substantially identical height H1, and in a second subgroup of two or more preform moulds all preform moulds have substantially identical height H2, wherein the height H2 exceeds the height H1, and wherein optionally all preform moulds have substantially identical length L. The width W may, for example, be between 1.8 and 2.2 meters, such as 2 meters. The height H1 may, for example, be between 0.5 and 0.7 meters, such as 0.6 meters. The height H2 may, for example, be between 0.8 and 1.0 meters, such as 0.9 meters. Thus, all preform moulds may have a substantially identical width W of between 1.8 and 2.2 meters, e.g. 2 meters, wherein in a first subgroup of two or more preform moulds all preform moulds have a substantially identical height H1 of between 0.5 and 0.7 meters, e.g. 0.6 meters, and in a second subgroup of two or more preform moulds all preform moulds have a substantially identical height H2 of between 0.8 and 1.0 meters, e.g. 0.9 meters.

According to a preferred embodiment, each preform mould has a width W of between 1 and 3 meters and a height H of between 0.5 and 2 meters. This results in slenderer preform moulds as compared to prior art systems and greatly facilitates the space- and time-saving effects and the desired automation resulting from present invention.

In a preferred embodiment of the present invention, each preform mould has a width W of between 1 and 3 meters, preferably between 1.8 and 2.2 meters, and a height H of 1 meter or less, preferably between 0.6 and 1 meters.

In another embodiment of the present invention, each preform mould has a length L of between 15 and 30 meters.

In some embodiments, each preform mould has a length-width ratio of at least 5:1. In other embodiments, each preform mould has a length-width ratio of at least 5:1, such as at least 10:1. In a preferred embodiment, each preform mould has a length-width ratio of at least 15:1.

In some embodiments, each preform mould comprises a structure having a moulding surface, such as a composite or metal structure having a moulding surface, the structure being mounted on or in between a support structure, such as a frame, preferably a metal frame. For example, a structure having a moulding surface may be mounted in between two laterally extending frames to form a preform mould. Thus, the frames may define the height, length and/or width of the preform mould.

According to one embodiment of the present invention, each preform mould has a bottom surface, a moulding surface and an upper edge adjacent to the moulding surface, wherein the preform moulds are stackable such that the upper edge of an underlying preform mould supports the bottom surface of an overlying preform mould. Such a stacked arrangement was found to facilitate storage and handling of preform moulds during blade manufacturing. It can also be advantageously used for transportation purposes. For example, a quantity of four, six or eight preform moulds could be stored and/or transported on a suitable trolley. Typically, each preform mould will comprise two opposing upper edges adjacent to the moulding surface, wherein the preforms are stackable such that the two opposing upper edges of an underlying preform mould support the bottom surface of an overlying preform mould.

In a preferred embodiment, in a preform mould stack according to the present invention the preform moulds are interconnected via respective container fittings or container castings, wherein said container fittings or container castings are preferably arranged at the corners of two or more preform moulds stacked on top of each other.

In another embodiment of the present invention, the preform moulds comprise fastening means to fasten the preform moulds to each other when the preform moulds are stacked such that the upper edge of an underlying preform mould supports the bottom surface of an overlying preform mould. Such fastening means could, for example, include pins provided on the upper edge of the preform mould and corresponding holes provided in the bottom surface of the preform moulds, or vice versa.

It is particularly preferred that each preform mould is configured for moulding a preform which is to be arranged adjacent to one or more other preforms such that the adjacent preforms are oriented in a longitudinal or spanwise direction of the wind turbine blade. It is preferred that the longitudinal or generally lengthwise orientation of the preform moulds, and of the produced preforms, generally coincides with the longitudinal or spanwise direction of the wind turbine blade that is to be manufactured by using the preforms of the present invention.

Thus, the preform moulds of the present invention are particular useful for producing wind turbine blade halves from multiple preforms that are assembled along a longitudinal or spanwise plane. It is therefore preferred that the manufacturing system of the present invention is configured for producing a plurality of preforms which are to be assembled along a longitudinal or spanwise plane for obtaining a wind turbine blade half or a part thereof, such as a root region.

The preform moulds of the present invention will preferably have a width that corresponds to only part of the circumference of the later blade half, as seen in its cross section, such as about one third of the circumference of the later blade half. Thus, for example, three preforms produced with the manufacturing system of the present invention may together account for the circumference of the blade half when arranged adjacent to each other in the blade mould.

In particular when manufacturing large blade halves, the fibre layup at the root end may be challenging. Fibre material may slide down the almost vertical blade mould walls due to the almost semi-circular cross section or circumference at the root end. The sliding of fibre material during manufacturing may lead to the formation of undesired wrinkles in the shell structure, which may present zones of structural weakness within the blade. The manufacturing system of the present invention addresses this challenge with a set of preforms, for example three preforms, that together cover the entire circumference of the blade half, as seen in its cross section for an improved and safer layup process at the blade mould.

According to one embodiment of the present invention, the fibre lay-up station is arranged to place a fibre material into two or more preform moulds simultaneously. Preferably, the fibre lay-up station is arranged to place a fibre material into three or more preform moulds simultaneously. This could be achieved by a fibre lay-up device servicing two or more preform moulds simultaneously. In other embodiments, the fibre lay-up station could comprise two or more fibre lay-up devices.

In another embodiment of the present invention, the system comprises four or more preform moulds. In another embodiment, the system comprises five or more preform moulds. In another embodiment, the system comprises six or more preform moulds. In another embodiment, the system comprises seven or more preform moulds. In another embodiment, the system comprises eight or more preform moulds. In another embodiment, the system comprises nine or more preform moulds. In another embodiment, the system comprises ten or more preform moulds.

In a preferred embodiment, each of the preforms obtainable by the manufacturing system of the present invention is configured to form a blade section starting from the root end of the blade. In other words, preferably each of the preforms obtainable by the manufacturing system of the present invention is configured to be arranged at the root end of the blade mould.

According to one embodiment of the present invention, the wind turbine blade part is a root laminate or a part thereof.

In another aspect, the present invention relates to a method of manufacturing a plurality of preforms for wind turbine blade parts, said method comprising
providing two or more preform moulds, each preform mould having a width W, a height H and a length L,
placing a fibre material and a binding agent into each preform mould, and
heating the fibre material and the binding agent to a temperature of between 40 and 200° C. to form a plurality of preforms,
   wherein at least two of the preform moulds have substantially identical width W and substantially identical height H.

In a preferred embodiment, the method comprises providing three or more, such as four or more, five or more, six or more, seven or more, or eight or more preform moulds. It is preferred that at least two of the preform moulds have substantially identical width W, substantially identical height H and substantially identical length L. In other embodiments at least three, such as at least four, five, six, seven or eight of the preform moulds have substantially identical width W, substantially identical height H and substantially identical length L.

Typically, the fibre material is placed successively onto the moulding surface of each preform mould. The fibre material may comprise glass fibres, carbon fibres or a combination thereof. According to a preferred embodiment of the method, a glass fibre material is placed into each preform mould, such as multiple layers of glass fibre material. The fibre material may advantageously be brought into contact with a binding agent before or during the fibre lay-up.

In another embodiment, the fibre material may include fibre rovings, such as glass fibre rovings. The lay-up process may include placing multiple single roving bundles into the mould, the roving bundles being preferably aligned unidirectionally. In a preferred embodiment, multiple layers of fibre rovings or roving bundles are successively placed into each preform mould, wherein the fibre rovings are fixated at one end of the preform mould, such as the root end. Due to the unitary/standardised design of the preform moulds, a fibre lay-up device may be custom-designed to the particular dimensions of said preform moulds, making even a more complex fibre lay-up, as the one described, worthwhile to the high throughput of unitary size preform moulds. In one embodiment the fibre lay-up device includes fixation means to fix fibre rovings at one end of the preform mould.

The binding agent can be added simultaneously with the fibres or subsequently to fibre lay-up. The binding agent is preferably present in an amount of 0.1-15 wt % relative to the weight of the fibre material. The binding agent may also be present in an amount of 5-40, preferably 10-20, gram per m2 of glass surface. In preferred embodiments, the binding agent is present in an amount of 0.5-5 wt %, preferably 0.5-2.5 wt %, relative to the weight of the fibre material. Advantageously, the binding agent is a thermoplastic binding agent. The binding agent may comprise a polyester, preferably a bisphenolic polyester.

In a preferred embodiment, the heating of the fibre material and the binding agent takes place at a temperature of between 40 and 160° C., preferably between 90 and 160° C.

An example of a suitable binding agent is a polyester marketed under the name NEOXIL 940. Examples include NEOXIL 940 PMX, NEOXIL 940 KS 1 and NEOXIL 940 HF 2B, all manufactured by DSM Composite Resins AG. Another example is a polyester resin marketed under the name C.O.I.M. FILCO® 661 FPG 005, which is a bisphenolic unsaturated polyester resin in powder form. Preferably, the binding agent is a polyester, preferably a bisphenolic polyester. In other embodiments, the binding agent is a hotmelt adhesive or based on a prepreg resin.

Usually, each preform mould will comprise a moulding surface for lay-up of fibre material to form the preform. In some embodiments of the present invention, the shape of the moulding surface may differ between preform moulds. Thus, while two or more preform moulds may have substantially identical width W, substantially identical height H, and optionally substantially identical length L, the shape and the curvature of the moulding surface may differ between the preform moulds.

It is particularly preferred that all preform moulds have substantially identical width W and substantially identical height H, and optionally substantially identical length L.

In a preferred embodiment, the preforms manufactured according to the afore-mentioned method are used as part of the root region of a wind turbine blade, such as the root laminate. The root region may extend up to 40 meters, such as up to 25 meters, from the root end of the blade, as seen in its longitudinal direction. In other embodiments, the root region may extend to the shoulder of the blade+/−5 meters. However, the preforms could also be used for other parts and regions of a wind turbine blade.

In one embodiment, the step of placing a fibre material and optionally a binding agent into each preform mould is carried out simultaneously for two or more, such as three or more, or four or more preform moulds. In other embodiments, the step of heating the fibre material and the binding agent is carried out simultaneously for two or more, such as three or more, or four or more preform moulds. It has been found by the present inventors that the unitary/standardised dimensions of the preform moulds of the present invention allow for a dedicated design of the fibre lay-up and heating stations, respectively. This allows for simultaneous fibre lay-up and/or heating of multiple preform moulds and for custom-tailored layouts of these stations, which are economically viable in view of the high throughput of the standardised/unitary mould dimensioning. This has been found to result in significant reduction of cycle time and cost.

In other embodiments, the step of placing a fibre material and optionally a binding agent into each preform mould is carried out for one preform mould at a time. In other embodiments, the step of heating the fibre material and the binding agent is carried out for one preform mould at a time.

In a preferred embodiment of the method, all preform moulds have substantially identical width W and substantially identical height H, and optionally substantially identical length L. As described with reference to the system of the present invention, according to preferred embodiments of the method of the present invention, each preform mould has a width W of between 1 and 3 meters and a height H of between 0.5 and 2 meters. In another preferred embodiment, each preform mould has a width W of between 1 and 3 meters, preferably between 1.8 and 2.2 meters, and a height H of 1 meter or less, preferably between 0.6 and 1 meters. In another embodiment, each preform mould has a length L of between 15 and 30 meters.

In another preferred embodiment of the method, all preform moulds have substantially identical width W, and wherein in a first subgroup of two or more preform moulds all preform moulds have substantially identical height H1, and in a second subgroup of two or more preform moulds all preform moulds have substantially identical height H2, wherein the height H2 exceeds the height H1. The width W may, for example, be between 1.8 and 2.2 meters, such as 2 meters. The height H1 may, for example be between 0.5 and 0.7 meters, such as 0.6 meters. The height H2 may, for example be between 0.8 and 1.0 meters, such as 0.9 meters. Thus, all preform moulds may have a substantially identical width W of between 1.8 and 2.2 meters, e.g. 2 meters, wherein in a first subgroup of two or more preform moulds all preform moulds have a substantially identical height H1 of between 0.5 and 0.7 meters, e.g. 0.6 meters, and in a second subgroup of two or more preform moulds all preform moulds have a substantially identical height H2 of between 0.8 and 1.0 meters, e.g. 0.9 meters.

According to another embodiment of the method, each preform mould has a bottom surface, a moulding surface and an upper edge adjacent to the moulding surface, wherein at least two preforms are stacked during the heating step such that the upper edge of an underlying preform mould supports the bottom surface of an overlying preform mould. Typically, each preform mould will comprise two opposing upper edges adjacent to the moulding surface, wherein the preforms are stackable such that the two opposing upper edges of an underlying preform mould support the bottom surface of an overlying preform mould.

Preferably, the wind turbine blade part is a blade half, a root laminate or a part thereof. Preferably, the wind turbine blade part is a blade half. In some embodiments of the inventive system or method, each preform has a length of at least 5, 7, 10, 15, 20 or 25 meters.

According to another embodiment, the binding agent is a thermoplastic binding agent. Typically, the fibre rovings are at least partially joined together by means of the binding agent by thermal bonding. In a preferred embodiment, the binding agent is a binding powder, such as a thermoplastic binding powder.

In one embodiment, the preforms of the present invention essentially consist of the fibre material and the binding agent. This means that the preforms contain no more than 10 wt %, preferably not more than 5 wt % or not more than 1 wt %, of material other than fibre material and binding agent relative to the total weight of the preform. According to another embodiment, the preform consists of the fibre material and the binding agent.

In another embodiment, the fibre material used for the preforms of the present invention essentially consists of glass fibres. This means that the fibre material contains not more than 10 wt %, preferably not more than 5 wt % or not more than 1 wt %, of material other than glass fibres relative to the total weight of the fibre material. According to another embodiment, the fibre material consists of glass fibres.

In one embodiment, the binding agent is present in an amount of 1-6 wt % relative to the weight of the fibre material. According to another embodiment, the melting point of the binding agent is between 40° and 220° C., preferably between 40 and 160° C. According to another embodiment, the binding agent comprises a polyester, preferably a bisphenolic polyester.

In one embodiment of the present invention, each preform essentially consists of the fibre material and the binding agent. According to another embodiment, the fibre material comprises fibre rovings, preferably glass fibre rovings. According to another embodiment, the fibre material comprises a fibre fabric, such as a fibre mat. In another embodiment, a preform may further comprise at least one fibre fabric such as a fibre mat. Fibre rovings may be arranged on top and/or below such fabric.

It will be understood that any of the above-described features may be combined in any embodiment of the inventive method or system. In particular, features and embodiments described with regard to the system for the manufacture of preforms may also apply to the method of manufacturing a plurality of preforms, and vice versa. Likewise, features and embodiments described herein with regard to one aspect of the present invention may also be applied to, and combined with, each of the other aspects of the present invention.

In another aspect, the present invention relates to a plurality of preforms obtainable by the afore-described method.

In yet another aspect, the present invention relates to a manufacturing system for the manufacture of preforms for wind turbine blade parts, the system comprising
two or more, preferably three or more, preform moulds, each preform mould having a width W, a height H and a length L, each preform mould comprising a moulding surface configured for the manufacturing of a respective subsection a wind turbine blade, each subsection extending from the root end of the wind turbine blade,
a fibre lay-up station for placing a fibre material into the preform moulds, and
a heating station for heating the fibre material to form the preforms,
   wherein at least two of the preform moulds, preferably all of the preform moulds, have substantially identical width W and substantially identical height H, and preferably substantially identical length.

Preferably, each preform mould of the system comprises a moulding surface configured for the manufacturing of a different subsection of a wind turbine blade, each subsection extending from the root end of the wind turbine blade.

In another aspect, the present invention relates to a method of manufacturing a wind turbine blade part, the method comprising:
manufacturing a plurality of preforms according to the afore-described method of manufacturing a plurality of preforms,
arranging the plurality of preforms in a blade mould cavity, optionally together with additional material,
infusing resin to the blade mould cavity,
curing or hardening the resin in order to form the blade half.

Typically, the resin infusion step comprises vacuum assisted resin transfer moulding. In a preferred embodiment, the resin dissolves the binding agent of the preform.

The resin for injecting the preform during the manufacturing of wind turbine blade parts, such as a root laminate, may be an epoxy, a polyester, a vinyl ester or another suitable thermoplastic or duroplastic material. In other embodiments, the resin may be a thermosetting resin, such as epoxy, vinyl ester or polyester, or a thermoplastic resin, such as nylon, PVC, ABS, polypropylene or polyethylene.

The present invention also relates to a blade half obtainable by the method of manufacturing a wind turbine blade half.

In yet another aspect, the present invention relates to a manufacturing system for the manufacture of preforms for wind turbine blade parts, the system comprising
two or more preform moulds,
a rack for receiving the two or more preform moulds,
a fibre lay-up station for placing a fibre material into the preform moulds, and
a heating station for heating the fibre material to form the preforms.

It is preferred that the rack comprises two or more compartments or shelves for receiving each of the preform moulds in a respective compartment or shelve. In one embodiment the compartments or shelves are arranged vertically such that the preform moulds can be received at different heights within the rack. Preferably, the preform moulds are arranged vertically in the rack. Thus, the preforms moulds can advantageously be stored and/or transported prior to, after, or in between of undergoing different operations at the fibre lay-up station and the heating station. This was found by the present inventors to significantly save working space and thus operational cost.

In this aspect of the present invention, the preform moulds and/or the stations may be designed as described above for the other aspects of the invention.

In a related aspect, the present invention relates to a method of manufacturing a plurality of preforms for wind turbine blade parts, said method comprising
providing two or more preform moulds,
providing at least one rack for receiving the two or more preform moulds,
placing a fibre material and a binding agent into each preform mould, and
heating the fibre material and the binding agent to a temperature of between 40 and 200° C. to form a plurality of preforms,
   wherein the preform moulds are stored and/or transported in the rack before and/or after the step of placing a fibre material and a binding agent into each preform mould or before and/or after the step of heating the fibre material and the binding agent to a temperature of between 40 and 200° C. to form a plurality of preforms.

In this aspect of the present invention, the preform moulds, the rack and/or other method features may be designed as described above for the other aspects of the invention.

In one embodiment, the preform moulds are stored and/or transported in the rack before the step of placing a fibre material and a binding agent into each preform mould. In another embodiment, the preform moulds are stored and/or transported in the rack after the step of placing a fibre material and a binding agent into each preform mould. In another embodiment, the preform moulds are stored and/or transported in the rack before the step of heating the fibre material and the binding agent to a temperature of between 40 and 200° C. to form a plurality of preforms. In another embodiment, the preform moulds are stored and/or transported in the rack after the step of heating the fibre material and the binding agent to a temperature of between 40 and 200° C. to form a plurality of preforms.

In another aspect, the present invention relates to a stack of two or more preform moulds, such as three or more preform moulds, or four or more preform moulds, or five or more preform moulds, the preform moulds being suitable for the manufacture of preforms for wind turbine blade parts. In said stack, the preform moulds are preferably interconnected by container fittings or container castings, which are preferably arranged at the corners of the preform moulds. Each preform mould of said stack has a width W, a height H and a length L. In one embodiment of said stack, at least two of the preform moulds have substantially identical width W. In another embodiment, at least two of the preform moulds have substantially identical height H. In another embodiment, at least two of the preform moulds have substantially identical length L. In a preferred embodiment, at least two of the preform moulds have substantially identical width W, substantially identical height H and substantially identical length L.

As used herein, the term “wt %” means weight percent. The term “relative to the weight of the fibre material” means a percentage that is calculated by dividing the weight of an agent, such as a binding agent, by the weight of the fibre material. As an example, a value of 1 wt % relative to the weight of the fibre material corresponds to 10 g of binding agent per kilogram of fibre material.

As used herein, the term “substantially identical” denotes two or more dimensions of length, width or height, respectively, that do not differ from each other by more than 5%, preferably more than 4%, such as more than 3% or more than 2%, the percentage being calculated on the basis of the longest of the length dimensions, the longest of the width dimensions and/or the longest of the height dimensions, respectively.

### DETAILED DESCRIPTION OF THE INVENTION

The invention is explained in detail below with reference to embodiments shown in the drawings, in which

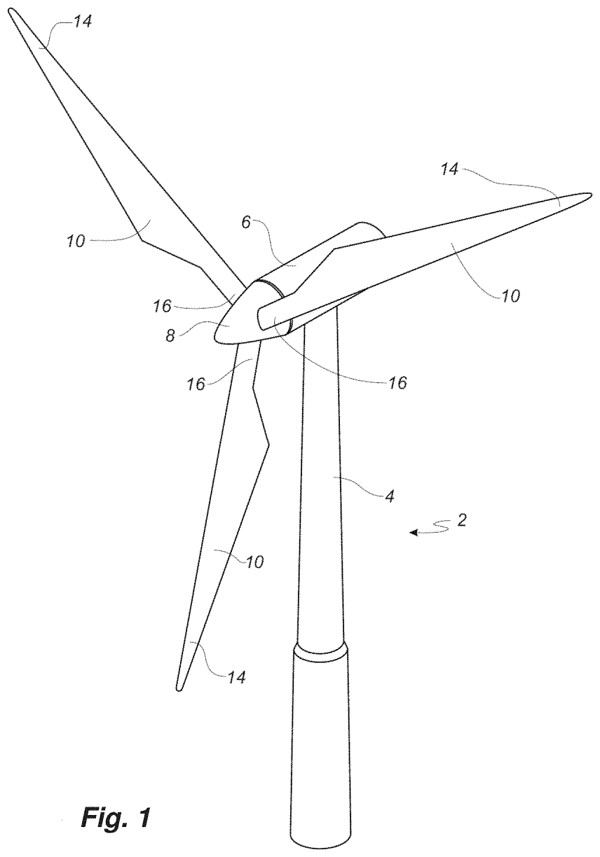

FIG. 1 shows a wind turbine,

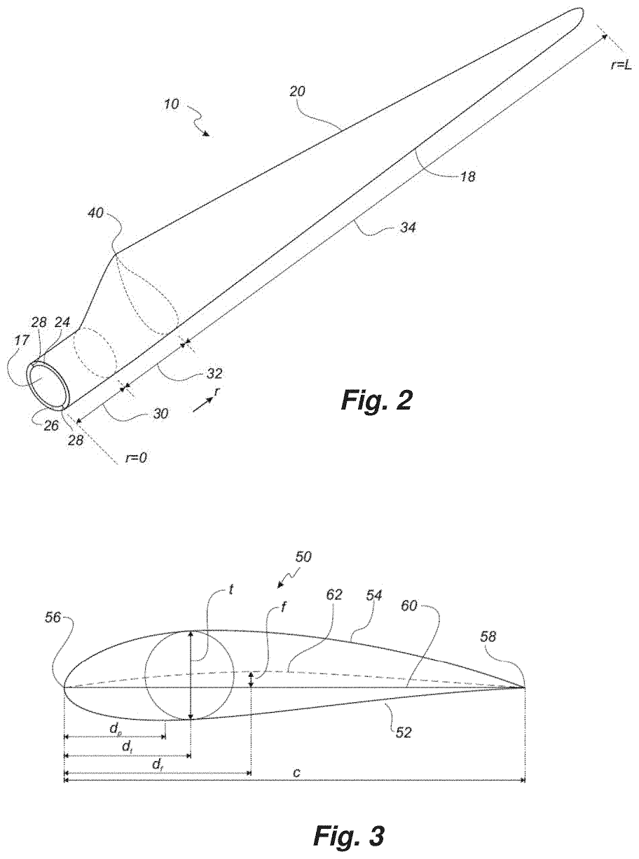

FIG. 2 shows a schematic view of a wind turbine blade,

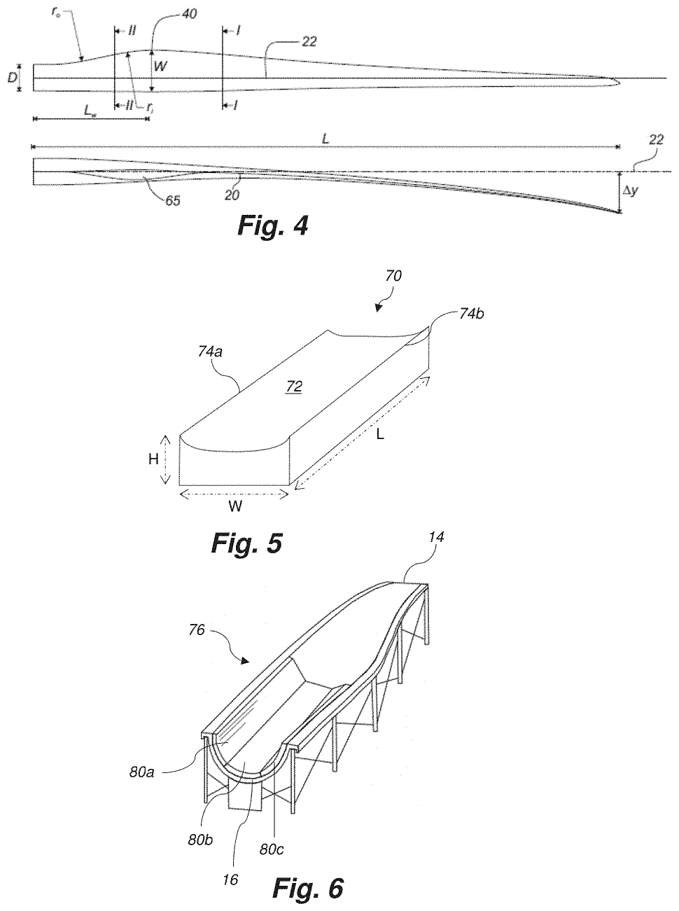

FIG. 3 shows a schematic view of an airfoil profile through section I-I of FIG. 4,

FIG. 4 shows a schematic view of the wind turbine blade, seen from above and from the side,

FIG. 5 is a perspective drawing of a preform mould according to the present invention,

FIG. 6 is a perspective drawing of a blade mould containing preforms according to the present invention,

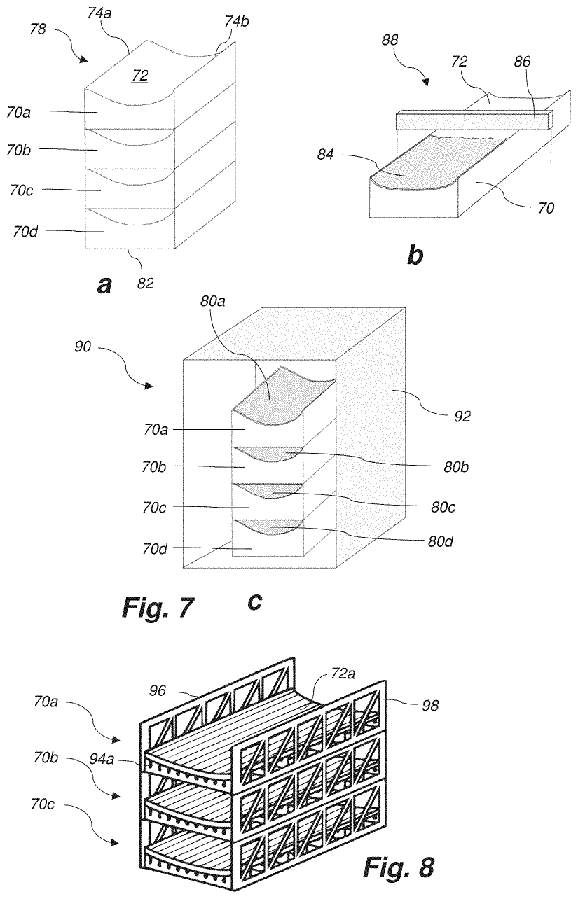

FIG. 7 is a perspective drawing illustrating different parts of the manufacturing system of the present invention,

FIG. 8 is a perspective view of a preform mould stack according to another embodiment of the present invention, and

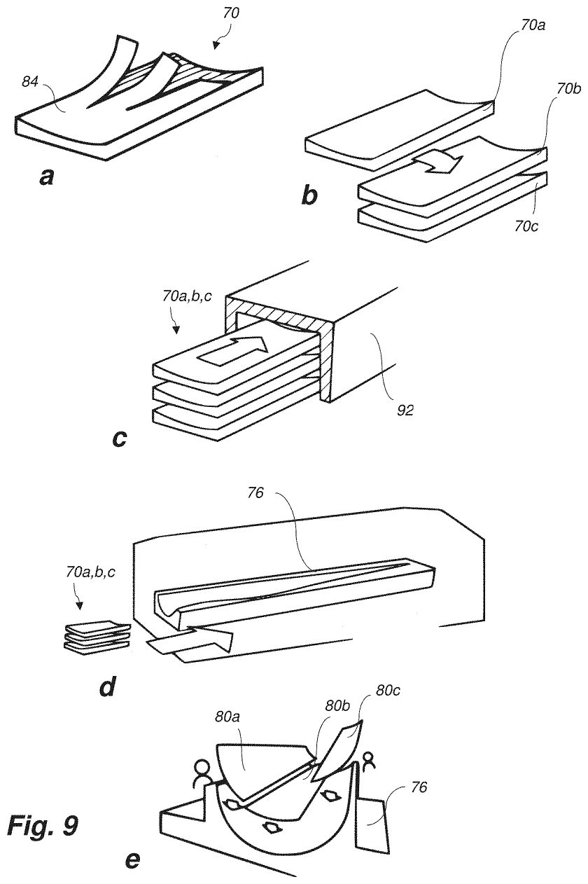

FIG. 9 is a schematic view illustrating different steps of a method of manufacturing a wind turbine blade half according to the present invention.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 furthest from the hub 8.

FIG. 2 shows a schematic view of a first embodiment of a wind turbine blade 10 according to the invention. The wind turbine blade 10 has the shape of a conventional wind turbine blade and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

FIGS. 3 and 4 depict parameters which are used to explain the geometry of the wind turbine blade according to the invention. FIG. 3 shows a schematic view of an airfoil profile 50 of a typical blade of a wind turbine depicted with the various parameters, which are typically used to define the geometrical shape of an airfoil. The airfoil profile 50 has a pressure side 52 and a suction side 54, which during use—i.e. during rotation of the rotor—normally face towards the windward (or upwind) side and the leeward (or downwind) side, respectively. The airfoil 50 has a chord 60 with a chord length c extending between a leading edge 56 and a trailing edge 58 of the blade. The airfoil 50 has a thickness t, which is defined as the distance between the pressure side 52 and the suction side 54. The thickness t of the airfoil varies along the chord 60. The deviation from a symmetrical profile is given by a camber line 62, which is a median line through the airfoil profile 50. The median line can be found by drawing inscribed circles from the leading edge 56 to the trailing edge 58. The median line follows the centres of these inscribed circles and the deviation or distance from the chord 60 is called the camber f. The asymmetry can also be defined by use of parameters called the upper camber (or suction side camber) and lower camber (or pressure side camber), which are defined as the distances from the chord 60 and the suction side 54 and pressure side 52, respectively.

Airfoil profiles are often characterised by the following parameters: the chord length c, the maximum camber f, the position d_{f} of the maximum camber f, the maximum airfoil thickness t, which is the largest diameter of the inscribed circles along the median camber line 62, the position dₜ of the maximum thickness t, and a nose radius (not shown). These parameters are typically defined as ratios to the chord length c. Thus, a local relative blade thickness t/c is given as the ratio between the local maximum thickness t and the local chord length c. Further, the position dₚ of the maximum pressure side camber may be used as a design parameter, and of course also the position of the maximum suction side camber.

FIG. 4 shows other geometric parameters of the blade. The blade has a total blade length L. As shown in FIG. 3, the root end is located at position r=0, and the tip end located at r=L. The shoulder 40 of the blade is located at a position r=L_{w}, and has a shoulder width W, which equals the chord length at the shoulder 40. The diameter of the root is defined as D. The curvature of the trailing edge of the blade in the transition region may be defined by two parameters, viz. a minimum outer curvature radius rₒ and a minimum inner curvature radius rᵢ, which are defined as the minimum curvature radius of the trailing edge, seen from the outside (or behind the trailing edge), and the minimum curvature radius, seen from the inside (or in front of the trailing edge), respectively. Further, the blade is provided with a prebend, which is defined as Δy, which corresponds to the out of plane deflection from a pitch axis 22 of the blade.

FIG. 5 is a perspective view of a preform mould 70 according to the present invention. The preform mould 70 comprises a moulding surface 72 for moulding a preform and two adjacent edges 74a, 74b. As illustrated in FIG. 5, the preform mould 70 has a width W, a height H and a length L. For example, the width W may be 2 m, the height H may be 1 meter and the length L may be 20 m. In an example of the manufacturing system of the present invention, at least two of the preform moulds have substantially identical width W, height H and length L.

As illustrated in FIG. 6, the manufactured preforms 80a, 80b, 80c can be laid up in a blade mould 76 to form part of a wind turbine blade, such as the root laminate. It is particularly preferred that the preforms manufactured according to the present invention are used for a blade section starting from the root end 16 of the blade, such as the root region. As explained above, the preforms 80a, 80b, 80c are arranged in the blade mould, usually together with additional material, after which resin is infused, which is subsequently cured or hardened in order to form the blade part, such as a blade half.

FIGS. 7a, b and c illustrate different aspects of the preform manufacturing system of the present invention. FIG. 7a shows a stacked arrangement 78 of four preform moulds 70a-d, all preform moulds 70a-d having substantially identical width W, substantially identical height H and substantially identical length L. They are stacked such that the upper edges 74a, 74b of an underlying preform mould support the bottom surface 82 of an overlying preform mould. This is an efficient arrangement for storage and/or transport of the preform moulds.

A schematic fibre lay-up station 88 for placing a fibre material 84 into the preform moulds is shown in FIG. 7b. It comprises a fibre lay-up device 86 for laying fibres and optionally a binding agent onto the moulding surface 72 of the preform mould 70. Unlike the embodiment shown in FIG. 7b, the fibre lay-up station 88 and the fibre lay-up device 86 may also be arranged to lay up fibres in multiple, such as two or three, preform moulds simultaneously. This is greatly facilitated by the modular/standardised dimensions of the preform moulds of the present invention.

Finally, the laid-up fibre material and the binding agent are heated at the heating station 90 (FIG. 7c). In the embodiment shown in FIG. 7c, multiple preform moulds 70a-d, in a stacked arrangement, are simultaneously heated in an oven 92 to manufacture a plurality of preforms 80a-d. Again, this is facilitated by the modular/standardised dimensions of the preform moulds of the present invention.

FIG. 8 shows another embodiment of preform moulds 70a, 70b, 70c according to the present invention. Each preform mould 70a comprises a structure 94a having a moulding surface 72a, the structure 94a being mounted in between two laterally extending frames 96, 98. Thus, the preform moulds 70a, 70b, 70c can be conveniently stacked upon each other.

FIG. 9 illustrates different steps of a method of manufacturing a wind turbine blade half according to the present invention. First, a plurality of preforms is manufactured according to the above-described method including arranging a fibre material 84 and a binding agent into each preform mould 70; see FIG. 9a. The preform moulds are then stacked such that the upper edge of an underlying preform mould 70c supports the bottom surface of an overlying preform mould 70b; see FIG. 9b. The stacked preform moulds are subsequently heated, for example in oven 92, to form a plurality of preforms; see FIG. 9c. The preforms may be transferred, for example in the form of the stack of preform moulds 70a,b,c, to the blade mould 76, i.e. the mould for the blade half; see FIG. 9d. Next, the preforms 80a,b,c are arranged in the blade mould 76, optionally together with additional material, preferably at the root end of the blade mould 76 as illustrated in FIG. 9e; followed by resin infusion and curing or hardening in order to form the blade half, or a part thereof.

The invention is not limited to the embodiments described herein, and may be modified or adapted without departing from the scope of the present invention.

### LIST OF REFERENCE NUMERALS

2 wind turbine
4 tower
6 nacelle
8 hub
10 blade
14 blade tip
16 blade root
18 leading edge
20 trailing edge
22 pitch axis
30 root region
32 transition region
34 airfoil region
40 shoulder/position of maximum chord
50 airfoil profile
52 pressure side
54 suction side
56 leading edge
58 trailing edge
60 chord
62 camber line/median line
70 preform mould
72 moulding surface of preform mould
74 edges of preform mould
76 blade mould
78 stack of preform moulds
80 preform
82 bottom surface of preform mould
84 fibre material
86 fibre lay-up device
88 fibre lay-up station
90 heating station
92 oven
94 structure
96 first laterally extending frame
98 second laterally extending frame
H height of preform mould
L length of preform mould
W width of preform mould
c chord length
dₜ position of maximum thickness
d_{f} position of maximum camber
dₚ position of maximum pressure side camber
f camber
L blade length
r local radius, radial distance from blade root
t thickness
Δy prebend

1. A manufacturing system for the manufacture of preforms (80) for wind turbine blade parts, the system comprising
two or more preform moulds (70), each preform mould (70) having a width W, a height H and a length L,
a fibre lay-up station (88) for placing a fibre material into the preform moulds (70), and
a heating station (90) for heating the fibre material to form the preforms,
wherein at least two of the preform moulds (70) have substantially identical width W and substantially identical height H.

2. A manufacturing system according to claim 1, wherein all preform moulds (70) have substantially identical width W and substantially identical height H, and optionally substantially identical length L.

3. A manufacturing system according to claim 1, wherein all preform moulds (70) have substantially identical width W, and wherein in a first subgroup of two or more preform moulds (70) all preform moulds (70) have substantially identical height H1, and in a second subgroup of two or more preform moulds (70) all preform moulds (70) have substantially identical height H2, wherein the height H2 exceeds the height H1.

4. A manufacturing system according to claim 1, wherein each preform mould (70) has a width W of between 1 and 3 meters and a height H of between 0.5 and 2 meters.

5. A manufacturing system according to claim 1, wherein each preform mould (70) has a width W of between 1 and 3 meters and a height H of 1 meter or less.

6. A manufacturing system according to claim 1, wherein each preform mould (70) has a length L of between 15 and 30 meters.

7. A manufacturing system according to claim 1, wherein each preform mould (70) has a bottom surface (82), a moulding surface (72) and an upper edge (74) adjacent to the moulding surface, wherein the preforms are stackable such that the upper edge (74) of an underlying preform mould (70) supports the bottom surface (82) of an overlying preform mould (70).

8. A manufacturing system according to claim 1, wherein the fibre lay-up station (88) is arranged to place a fibre material into two or more preform moulds (70) simultaneously.

9. A manufacturing system according to claim 1, wherein the system comprises four or more preform moulds (70).

10. A manufacturing system according to claim 1, wherein the wind turbine blade part is a blade half, a root laminate or a part thereof.

11. A method of manufacturing a plurality of preforms for wind turbine blade parts, said method comprising
providing two or more preform moulds (70), each preform mould (70) having a width W, a height H and a length L,
placing a fibre material and a binding agent into each preform mould (70), and
heating the fibre material and the binding agent to a temperature of between 40 and 200° C. to form a plurality of preforms,
wherein at least two of the preform moulds (70) have substantially identical width W and substantially identical height H.

12. A method according to claim 11, wherein all preform moulds (70) have substantially identical width W and substantially identical height H, and optionally substantially identical length L.

13. A method according to claim 11, wherein all preform moulds (70) have substantially identical width W, and wherein in a first subgroup of two or more preform moulds (70) all preform moulds (70) have substantially identical height H1, and in a second subgroup of two or more preform moulds (70) all preform moulds (70) have substantially identical height H2, wherein the height H2 exceeds the height H1.

14. A method according to claim 11, wherein each preform mould (70) has a bottom surface (82), a moulding surface (72) and an upper edge (74) adjacent to the moulding surface (72), wherein at least two preforms are stacked during the heating step such that the upper edge (74) of an underlying preform mould (70) supports the bottom surface (82) of an overlying preform mould (70).

15. A method according to claim 11, wherein the wind turbine blade part is a blade half, a root laminate or a part thereof.

16. A method of manufacturing a wind turbine blade part, such as a blade half, the method comprising:
manufacturing a plurality of preforms (80) according to the method of claim 11,
arranging the plurality of preforms (80) in a blade mould (76), optionally together with additional material,
infusing resin to the blade mould (76),
curing or hardening the resin in order to form the blade part.

17. A method of manufacturing a wind turbine blade part according to claim 16, wherein each of the plurality of preforms (80) is arranged at the root end of the blade mould (76).
